(19) United States
(12) Patent Application Publication
(10) Pub. No.: US 2007/0162340 A1
(43) Pub. Date: Jul. 12, 2007

(54) Integrated consumer rewards/product placement advertising program

(76) Inventor: Joseph J. Spinoso, Tampa, FL (US)

Correspondence Address: SHUTTS & BOWEN, LLP, 100 S. ASHLEY DRIVE, SUITE 1500, TAMPA, FL, 33602, US

(21) Appl. No.: 11/650,884

(22) Filed: Jan. 8, 2007

Related U.S. Application Data
(60) Provisional application No. 60/756,629, filed on Jan. 6, 2006.

(51) Int. Cl. G06Q 30/00

(52) U.S. Cl. 705/14

(57) ABSTRACT

Various embodiments of systems, methods, devices, and computer software for implementing an integrated consumer rewards/product placement advertising program are provided. One embodiment comprises a product placement advertising method. One such method comprises: associating a media project with a rewards program; providing a product placement advertisement opportunity in the media project to an advertiser; producing and distributing the media project with a product placement advertisement associated with the advertiser; and providing access to the rewards program in exchange for a consumer engaging in a transaction to purchase or view the media project.

### CROSS-REFERENCE TO RELATED APPLICATION

This application claims the benefit of the priority of U.S. Provisional Patent Application Ser. No. 60/756,629, entitled “Movie Sweepstakes Challenge” and filed Jan. 6, 2006, which is hereby incorporated by reference in its entirety.

### BACKGROUND

Product placement advertising is a promotional technique used by advertisers and marketers, in which a real commercial product or service is used in fictional or non-fictional media, and the presence of the product is a result of an economic exchange. The economic exchange typically occurs between the advertiser/marketer and the provider (or an affiliate) of the media content or the distribution network. Unlike traditional media advertising where the advertising content appears separate from the media content (e.g., during “commercial breaks”), product placement advertisements appears in the underlying media content (e.g., in plays, films, television series, music videos, video games, books, etc.). Product placement occurs with the inclusion of a brand's logo, or a favorable mention or appearance of a product. This is typically done without disclosure, and under the premise that it is a natural part of the media project, although the advertisement may be blatantly advertised. Most major movie releases today contain product placements. The most common form is movie and television placements and more recently computer and video games.

### SUMMARY

Various embodiments of systems, methods, devices, and computer software for implementing an integrated consumer rewards/product placement advertising program are provided. One embodiment comprises a computer system for supporting an on-line movie-viewing rewards program. An example of such a computer system comprises: a server configured to communicate with a computer via a communications network; a participation validation module executable via the server, the participation validation module comprising logic configured to: prompt a user of the computer to enter a transaction identifier; receive the transaction identifier; and determine whether the transaction identifier is associated with an on-line movie-viewing rewards program; and a rewards program module executable via the server, the rewards program module comprising logic configured to: if the transaction identifier is associated with the on-line movie-viewing rewards program: determine a movie corresponding to the transaction identifier, the movie containing a product placement advertisement; select a question associated with the product placement advertisement; prompt the user for a response to the question; receive the response; and identify the user as a winner of the on-line movie-viewing rewards program if the response is correct.

Another embodiment comprises a product placement advertising method. One such method comprises: associating a media project with a rewards program; providing a product placement advertisement opportunity in the media project to an advertiser; producing and distributing the media project with a product placement advertisement associated with the advertiser; and providing access to the rewards program in exchange for a consumer engaging in a transaction to purchase or view the media project.

Another embodiment of a product placement advertising method comprises: associating a movie containing at least one product placement advertisement with a rewards program; enabling a consumer to participate in the rewards program in exchange for the consumer engaging in a transaction to purchase or view the movie; validating the consumer as having engaged in the transaction; providing to the consumer a question related to the at least one product placement advertisement; and awarding a prize to the consumer if the question is answered correctly.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a diagram illustrating the basic structure, implementation, and operation of one of a number of possible embodiments of an integrated consumer rewards/product placement advertising program.

FIG. 2 is a flowchart illustrating one of a number of possible embodiments of a method for implementing an integrated consumer rewards/product placement advertisement program.

FIG. 3 is a flowchart illustrating another embodiment of a method for implementing an integrated consumer rewards/product placement advertisement program.

FIG. 4 is a block diagram illustrating one of a number of possible embodiments of a computer system for supporting an integrated consumer rewards/product placement advertisement program.

FIG. 5 is a flowchart illustrating the architecture, operation, and/or functionality of an embodiment of the participation validation module and rewards program module of the on-line rewards/movie product placement advertising system of FIG. 4.

### DETAILED DESCRIPTION

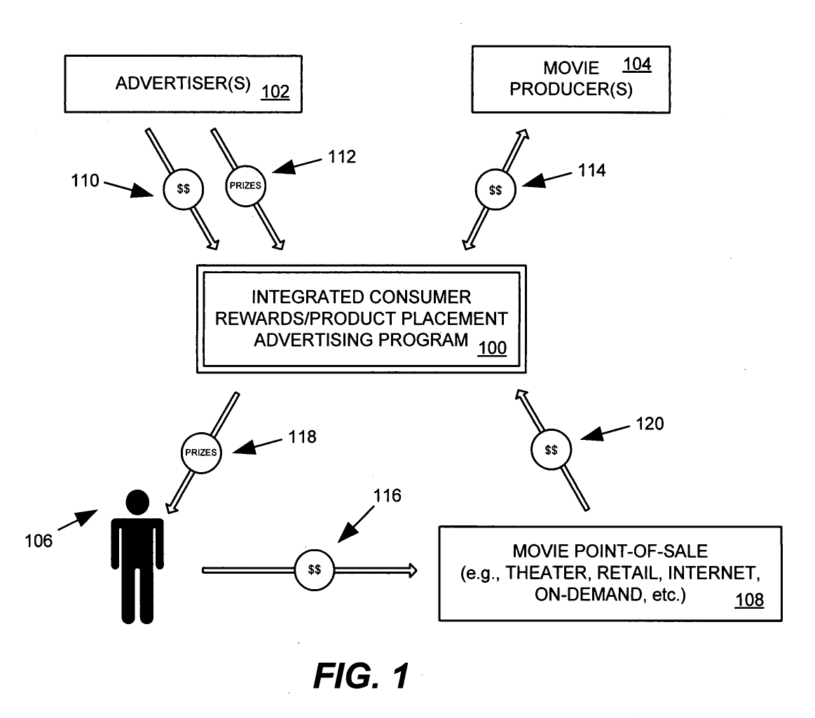

This disclosure relates to various embodiments of systems, methods, devices, and computer software for implementing an integrated consumer rewards/product placement advertising program or scheme. Various embodiments are described below in detail with reference to FIGS. 1-5. As an initial matter, however, an exemplary embodiment of such a scheme will be briefly described to illustrate certain general principles of the corresponding systems, methods, devices, and/or computer software.

As the name suggests, the exemplary integrated consumer rewards/product placement advertising program comprises two basic components: (1) a product placement advertising component; and (2) a consumer rewards component. The product placement advertising component supports a product placement advertising program between participating advertisers or marketers and participating media producers or providers. The program placement advertising program enables participating advertisers to place product placement advertisements into the content of a participating media project. In other words, the advertising content is integrated into the content of the media project, rather than appearing as a piece of distinct advertising content during, for example, a break in the media content. The media project may comprise any suitable media content, regardless the distribution medium. For example, the media project may comprise one of the following, or any other suitable, types of media projects: a full-length movie or motion picture; a television show; a made-for-TV movie; independently-produced multimedia content; or a clip or portion of any of the foregoing. The media project may be distributed in any suitable manner. For instance, the media project may be distributed via a theatrical release, a video release, the Internet, on-demand video, or any other suitable distribution scheme. Furthermore, the product placement advertising program may implement any known or later-developed schemes, technologies, production techniques, business methods, etc. It should be appreciated, however, with reference to this disclosure that the product placement advertising program provides various incentives and benefits to participating advertisers and content producers. For example, the integrated consumer rewards/product placement advertising program may provide advertising opportunities and/or revenue opportunities to participating advertisers or marketers, as well as revenue, funding, and/or investment opportunities to participating content producers or providers.

The second component (the consumer rewards component) supports a rewards program for consumers who purchase or view the media project. In this regard, the rewards program is designed to encourage consumers to engage in transactions associated with the media project (e.g., buy a ticket to see a movie in the theatre, purchase or rent a DVD, purchase a movie on the Internet or via an on-demand distribution system, etc.). Consumers obtain access to the consumer rewards program by engaging in the economic transaction associated with the media project. For example, when the consumer engages in the applicable transaction associated with a particular media project, a transaction identifier is provided to the consumer. The transaction identifier is used to manage access to the rewards program. If the consumer has a transaction identifier associated with one of the participating media projects, access will be granted to the rewards program. After access is granted, the consumer is asked one or more questions about the nature of one or more of the product placement advertisements contained in the media project. For example, the consumer may be asked to identify the make or model of the sports car driven by one of the main characters in a movie, or perhaps the type of laptop computers used by the bank robbers. If the consumer correctly answers one or more of the questions, the consumer may win a prize, receive reward points, or otherwise be credited as part of the rewards program for correctly answering the question. The prizes may correspond to the product placement advertisement (e.g., if the laptop computer question is correctly answered, the consumer may receive a free laptop computer, or points toward one). It should be appreciated that the consumer rewards component of the integrated consumer rewards/product placement advertising program may support any known or later-developed rewards systems, incentives, affinity marketing schemes, etc.

The consumer rewards component may be structured with various additional features. For example, in one embodiment, the rewards program may be structured so that a consumer can gain access to additional questions (and the accompanying possibility of winning more points, prizes, etc.) for the same media project by, for example, paying a premium for an initial transaction or by engaging in follow-up transactions. In this manner, the integrated consumer rewards/product placement advertising program may increase revenues for the media project based on increased volumes or per transaction margins.

Furthermore, it should be appreciated that the consumer rewards component provides various incentives and benefits to participating advertisers, content producers, and consumers. The possibility of winning prizes and the accompanying entertainment value of the consumer rewards program to consumers, may encourage them to pay more per transaction for a participating media project, engage in more transactions for a participating media project, or engage in a transaction for a media project when not otherwise disposed to doing so because of the consumer rewards component. Again, the increased volumes or margins may promote higher revenues for participating producers, as well as provide more meaningful consumer feedback, advertising analytics, etc. to participating advertisers or marketers. It should be further appreciated that the structure and operation of the integrated consumer rewards/product placement advertising program (and the interplay between the product placement advertising method and the consumer rewards component) provides a unique mutually-beneficial collection of incentives and benefits for consumers, advertisers, movie producers, point-of-sale entities and affiliates, etc.

FIG. 1 illustrates one of a number of possible embodiments of an integrated consumer rewards/product placement advertising program 100 (referred to, in shorthand, as integrated program 100). As illustrated in FIG. 1, integrated program 100 may encourage and support relationships with various entities associated with media projects. In the embodiment in FIG. 1, integrated program 100 supports relationships with: advertiser(s) 102, media producers or providers (e.g., movie producers 104), consumers 106, and point-of-sale (POS) entities (e.g., movie POS entities 108).

The central relationship of integrated program 100 is the affiliation with the source of the media project—e.g., media producer, media provider, movie producer 104, or a related entity. As illustrated by reference arrow 114, integrated program 100 establishes a business relationship with one or more movie producer(s) 104. The business relationship may be formal or informal and may involve any desirable terms. In the embodiment illustrated in FIG. 1, the business relationship comprises an economic exchange between movie producer 104 (or an affiliated entity) and integrated program 100. For example, movie producer 104 may compensate the provider of integrated program 100 in exchange for being affiliated with the program. In alternative embodiments, movie producer 104 may receive compensation from integrated program 100, in the form of, for example, shared revenues from operation of integrated program 100, rights or access to advertising opportunities, rights or access to POS opportunities, etc.

Integrated program 100 also establishes relationships with advertiser(s) 102. In one aspect of integrated program 100, advertiser(s) 102 represent the source of the product placement advertisements for the media projects and, therefore, the revenue, funding, or investment opportunities for movie producers 104. In another aspect, the media projects represent the source of product placement advertisement opportunities for advertiser(s) 102. In this regard, it should be appreciated that integrated program 100 may be structured to establish multiple relationships and broker arrangements between advertiser(s) 102 and movie producers 104. As illustrated by reference arrow 110, advertiser(s) 102 may compensate the provider of integrated program 100 in exchange for being affiliated with the program. Advertiser(s) 102 may also provide prizes to integrated program (reference arrow 112) which may be used as the rewards in connection with the consumer rewards component of integrated program 100. The prizes may be related to the nature of the particular product placement advertisement. For example, an electronics manufacturer may be given a product placement advertisement slot or opportunity in a movie and, accordingly, supply electronics to integrated program 100 to be provided to consumers 106 as prizes for correctly answering questions about the corresponding product placement advertisement in the movie.

As mentioned above, integrated program 100 also supports a consumer rewards program for consumers 106. The rewards program is designed to encourage consumers to engage in commercial transactions (reference arrow 116) associated with the participating media projects via interactions with a POS entity 108. Consumers 106 engage in the commercial transaction (reference arrow 116), receive a transaction identifier (e.g., on a ticket stub, sales receipt, electronic receipt, etc.), view the media project, obtain access to the consumer rewards program via the transaction identifier, and then answer questions about the product placement advertisements. If question(s) are correctly answered, consumers 106 may be provided prizes, or otherwise rewarded in accordance with the rules of the program.

POS entity 108 may comprise any brick-and-mortar or click-and-mortar on-line entity, depending on the nature of the transaction and the distribution medium for the media project. In this regard, integrated program 100 may also establish business relationships (reference arrow 120) with POS entities 108 to facilitate operation of the consumer rewards component. In the embodiment illustrated in FIG. 1, POS entity 108 may compensate the provider of integrated program 100, although it should be appreciated that alternative business arrangements may be desirable to implement the program.

The relationship between consumers 106 and integrated program 100 is generally captured by reference arrow 118. The consumer rewards program may be implemented as an on-line program operated via a web site, although other computer-implemented and non-computer-implemented methods may be employed.

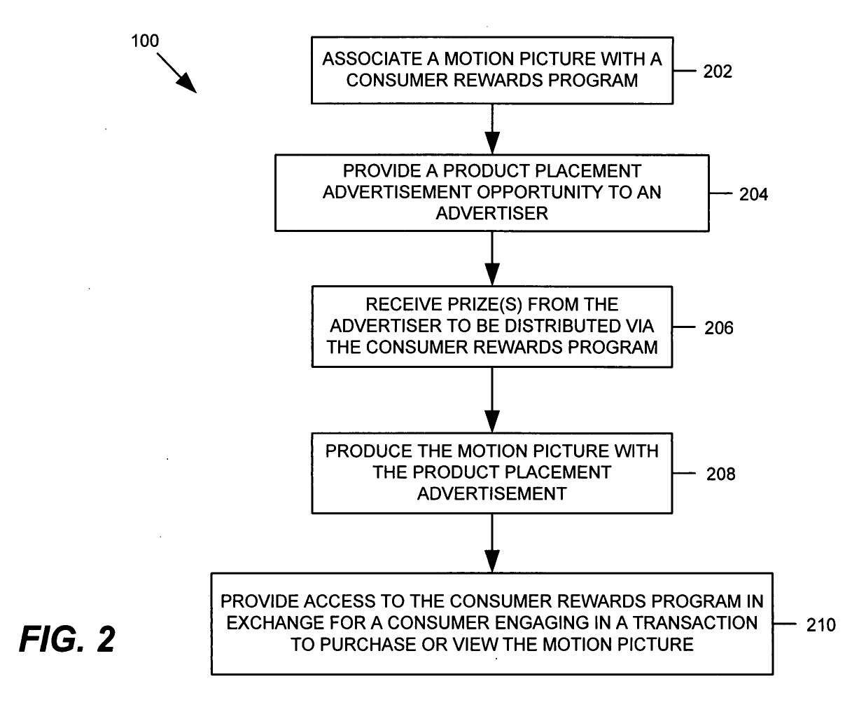

FIG. 2 illustrates one of a number of possible embodiments of a method for implementing integrated program 100. At block 202, a media project (e.g., a movie) is associated with integrated program 100. At block 204, a product placement advertisement opportunity is provided to an advertiser 102. At block 206, advertiser 102 provides prizes to integrated program 100, which are to be distributed to consumers 106 via integrated program 100. At block 208, the media project is produced containing a product placement advertisement for advertiser 102. At block 210, consumers 106 are provided access to integrated program 100 in exchange for engaging in a transaction to purchase or view the media project.

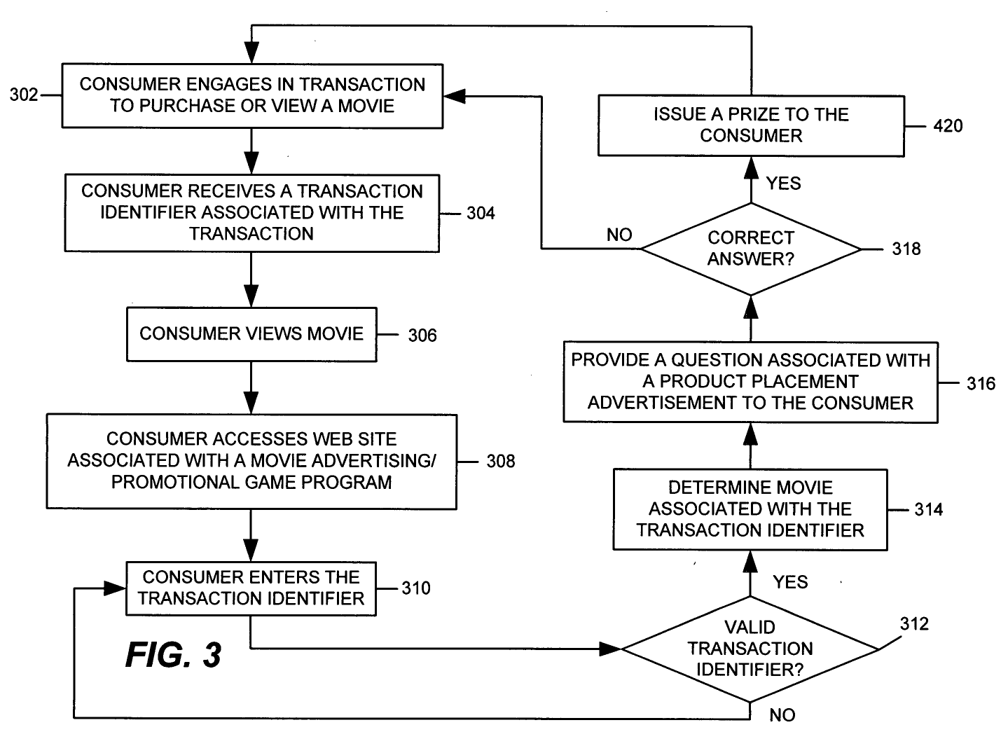

FIG. 3 illustrates an embodiment of a method for implementing integrated program 100 via an on-line rewards program. The on-line rewards program may be structured as a sweepstakes-type program. At block 302, a consumer 106 engages in a transaction to purchase or view a media project affiliated with integrated program 100 and promoted to consumer 106 as such. At block 304, consumer 106 receives a transaction identifier associated with the transaction and identifying the media project. The transaction identifier may be provided on, for example, a ticket stub, a sales receipt, an electronic receipt, or otherwise provided to consumer 106. At block 306, consumer 106 views the media project, preferably attempting to remember as much as possible about potential product placement advertisements. At block 308, consumer 106 accesses a web site affiliated with integrated program 100. At block 310, consumer 106 enters the transaction identifier received at block 304. At decision block 312, the web site determines whether the entered transaction identifier is a valid identifier. If the entered transaction identifier is not valid, consumer 106 may be given additional opportunities to enter a valid identifier (either at this or subsequent visits to the web site). If the entered transaction identifier is a valid identifier, at block 314, the web site determines the media project associated with the valid transaction identifier. At block 316, the web site provides a question to consumer 106 regarding a product placement advertisement contained in the media project. If consumer 106 correctly answers the question (decision block 318), consumer 106 may be issued a prize or other rewards. If consumer 106 does not correctly answer the question, additional attempts may be made by engaging in additional transactions (e.g., buying additional tickets, re-renting a DVD, purchasing a DVD, an on-demand video, etc.).

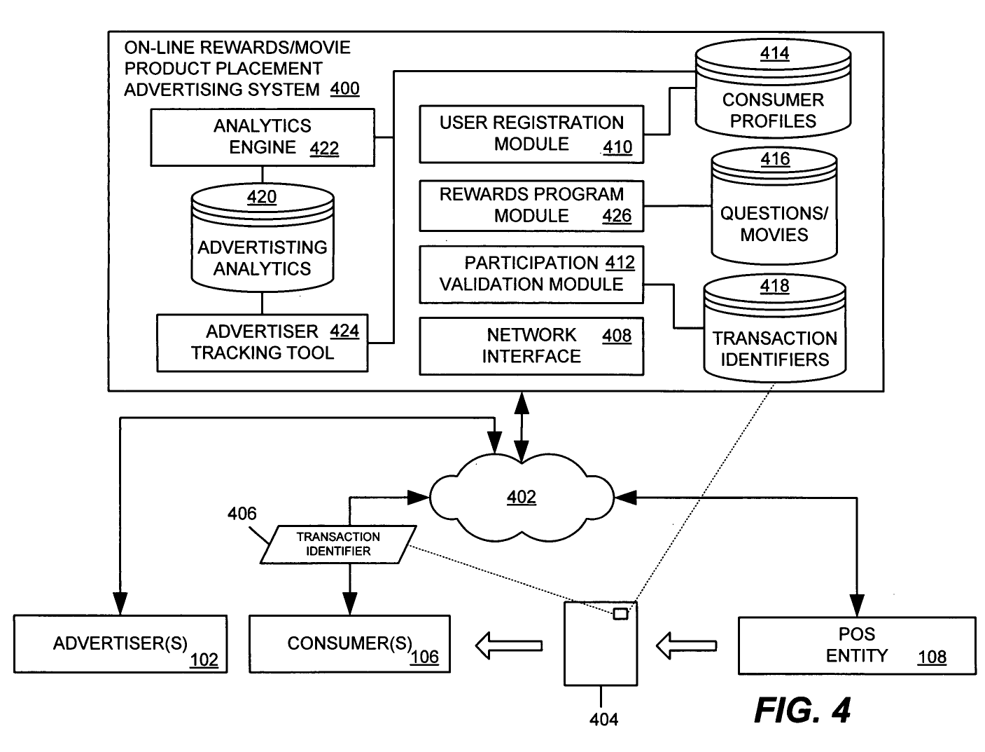

As mentioned above with respect to FIG. 3, it should be appreciated that one or more aspects of integrated program 100 may be implemented via a computer system. FIG. 4 illustrates one of a number of possible embodiments of a computer system 400 for supporting an integrated on-line rewards/movie product placement advertising system. Computer system 400 enables advertiser(s) 102, consumers 106, and movie POS entities 108 to interface with relevant user features, functionality, etc. of the integrated program via a communication network 402. Communication network 402 may be implemented with any communication medium (wired or wireless) and any known or later-developed communication technologies, architecture, protocols, etc. In one of a number of possible embodiments, communication network 402 comprises a wide area network, such as the Internet. Advertisers 102, consumers 106, and POS entities 108 may interface with computer system 400 via any suitable computer device and associated software (e.g., a web browser). Computer system 400 may comprise a server, such as, a web server, or multiple connected servers configured to communicate via communication network 402.

In the embodiment illustrated in FIG. 4, computer system 400 comprises a network interface 408 configured to interface with computer(s) via communication network 402, various software tools (and associated databases) for implementing the integrated program, and one or more processors (not shown) for running the software tools. In one embodiment, the software tools and databases include: a user registration module 410; a consumer profiles database 414; a participation validation module 412; a transaction identifiers database 418; a rewards program module 426; a questions/movies database 416; an analytics engine 422; an advertiser tracking tool 424; and an advertising analytics database 420.

In general, the software tools and databases comprise logic and memory for managing and providing the various aspects, features, functionality, etc. of the integrated program. User registration module 410 controls the process of registering consumers 106 with computer system 400 and enables consumers to manage their accounts. User registration module 410 may interface with an associated database (consumer profiles database 414) to store and access various types of information about consumers 106, accounts, account settings, etc. Advertiser tracking tool 424, analytics engine 422, and database 420 enable advertisers 102 to analyze and manage their product placement advertisements by, for example, tracking data about product placement advertisements. Tracking tool 424 and analytics engine 422 may interface with consumer profiles database 414 to access demographic and other marketing data associated with consumers 106.

In general, participation validation module 412 and rewards program module 426 comprise the logic for implementing certain aspects of the consumer rewards component of the integrated program. As mentioned above, the consumer rewards component is structured to encourage consumers 106 to purchase or view (or pay a premium for) the media project (e.g., movie, DVD, etc.). Consumers obtain access to the consumer rewards program by engaging in the commercial transaction associated with the media project with POS entities 108. As illustrated in FIG. 4, POS entity 108 may provide a document 404 to consumer 106 which includes a transaction identifier 406. Document 404 may comprise an electronic or paper receipt of the transaction, a ticket stub, game card, etc. Transaction identifier 406 may be pre-generated by the provider of integrated program 100 or automatically by computer system 400 or POS entity 108. For embodiments in which POS entity 108 generates transaction identifier 406, POS entity 108 may forward transaction identifier 406 to computer system 400 via communication network 402. Computer system 400 may then store transaction identifier 406 in transaction identifier database 418 as a valid identifier. Regardless the method of generating valid transaction identifiers, it should be appreciated that computer system 400 comprises the logic to recognize valid transaction identifiers. In the embodiment illustrated in FIG. 4, valid identifiers are stored in transaction identifiers database 418. In other embodiments, computer system 400 and/or the computer system operated by POS entity 108 may include appropriate algorithms, calculations, etc. for generating and/or subsequently determining valid numbers, without having to maintain a list of valid numbers. In this embodiment, transaction identifiers 406 may not necessarily be stored in transaction identifiers database 418, but may be determined based on the particular algorithm.

After consumer 106 receives transaction identifier 406, consumer 106 may view the media project containing the product placement advertisements of participating advertisers 102. Consumer 106 may also receive transaction identifier 406 after viewing the media project (e.g., upon returning a DVD rental). In some embodiments, transaction identifier 406 may also be contained in the media project itself (e.g., at the end of the movie). It should be appreciated that the media project may also be distributed via the computer system. For example, in one embodiment, a consumer 106 may pay to download the media project (or a clip of the media project containing the product placement advertisement) from computer system 400, view it, and then immediately answer questions about the project placement advertisement. In this embodiment, the process of validating consumer 106 for the consumer rewards component may be implemented without a transaction identifier 406 because computer system 400 has knowledge that the transaction has occurred and, therefore, can validate consumer 106 without issuing the identifier. Regardless the particular delivery method for transaction identifier 406 (or validation method), as part of the consumer rewards program, consumer 106 will be encouraged to view the media project and attempt to identify potential product placement advertisements and recall details about the advertisement. After viewing the media project, consumer 106 may access computer system 400 to obtain access to the consumer rewards program and answer questions about the product placement advertisements.

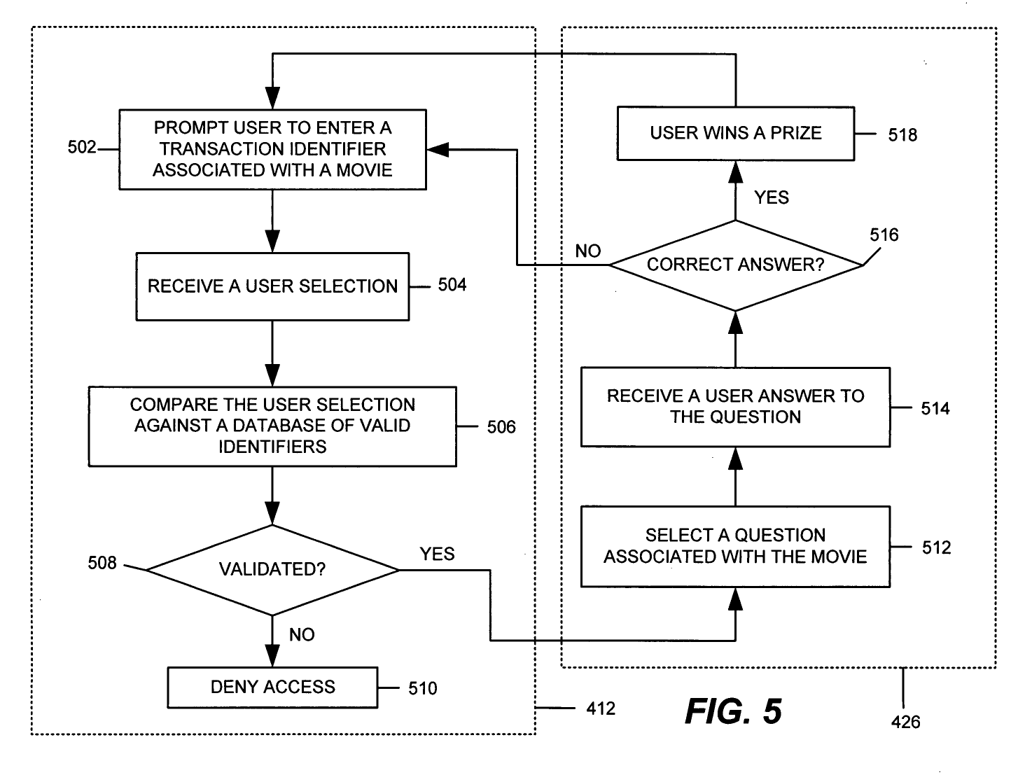

Referring to FIG. 5, the general operation of participation validation module 412 and rewards program module 426 will be described. As illustrated in FIG. 5, participation validation module 412 comprises blocks 502, 504, 506, and 508, while rewards program module 426 comprises blocks 512, 514, 516, and 518. It should be appreciated, however, that any process or logical descriptions of these modules (or the processes or methods steps described above) may represent modules, segments, or portions of code which include one or more executable instructions for implementing specific logical functions, steps, or acts in a process. It should be further appreciated that any logical functions may be executed out of order from that shown or discussed, including substantially concurrently or in reverse order, depending on the functionality involved, as would be understood by those reasonably skilled in the art. One of ordinary skill in the art will further appreciate that one or more of the aspects of the systems, methods, programs, etc. described above for implementing an integrated consumer rewards/product placement advertisement program may be implemented via a computer system, while others are manually implemented. Computer-implemented embodiments may support any communication protocol, computer language, etc. and may embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the logic embodying the applicable process for use by or in connection with the instruction execution system, apparatus, or device. The computer-readable medium may be, for example, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), a portable compact disc read-only memory (CDROM) (optical), and a communication signal containing the logic. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Referring again to FIG. 5, at block 502, participation validation module 412 prompts consumer 106 to enter a transaction identifier associated with a media project. At block 504, participation validation module 412 receives a user selection. At block 506, participation validation module 412 compares the user selection against transaction identifiers database 418 (or via appropriate algorithms, calculations, etc.). If the user selection is not a valid identifier (decision block 508), consumer 106 is not granted further access (block 510). If the user selection is a valid identifier, consumer 106 is granted further access and flow continues to rewards program module 426.

At block 512, rewards program module 426 selects a question from questions/movies database 416. In this regard, questions/movies database 416 may store various questions and answers about the product placement advertisements in the participating media projects. Rewards program module 426 may identify the appropriate media project based on the transaction identifier, and then select questions for that media project to ask consumer 106. Rewards program module 426 may prompt user to answer the selected question(s). At block 514, rewards program module 514 receives user answer(s) to the question(s). If the questions are correctly answered (decision block 516), consumer 106 may be rewarded in accordance with the particular rules of the program (e.g., receive a prize, collect points, etc.). For instance, where points are awarded, consumer 106 may be encouraged to play multiple times to accumulate more points. Consumer 106 may trade-in accumulated points to win available prizes. If the questions are not answered correctly, consumer 106 may be returned to the validation process or other areas of the web site.

Although this disclosure describes the invention in terms of exemplary or disclosed embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A product placement advertising method comprising:
associating a media project with a rewards program;
providing a product placement advertisement opportunity in the media project to an advertiser;
producing and distributing the media project with a product placement advertisement associated with the advertiser; and
providing access to the rewards program in exchange for a consumer engaging in a transaction to purchase or view the media project.

2. The product placement advertising method of claim 1, wherein the rewards program is at least partially implemented via a web site.

3. The product placement advertising method of claim 1, wherein the providing the product placement advertisement opportunity comprises providing the product placement advertisement opportunity in at least partial exchange for receiving a prize from the advertiser to be distributed via the rewards program.

4. The product placement advertising method of claim 3, wherein the prize relates to the product placement advertisement.

5. The product placement advertising method of claim 1, further comprising awarding a prize to the consumer for correctly responding to a question about the product placement advertisement.

6. The product placement advertising method of claim 5, wherein the providing access to the rewards program comprises:
prompting the consumer via a web site to enter a transaction identifier associated with the transaction to purchase or view the media project;
receiving via the web site a user selection;
providing a question to the consumer via the web site if the user selection matches the transaction identifier associated with the transaction, the question relating to the product placement advertisement;
receiving a user answer to the question; and
providing a prize to the consumer if the user answer is correct.

7. The product placement advertising method of claim 6, wherein the providing access to the rewards program involves:
providing the transaction identifier to the consumer at a point of sale; and
validating the transaction identifier via the web site.

8. The product placement advertising method of claim 7, wherein the transaction identifier is provided on at least one of a movie ticket, a sales receipt, and an electronic receipt.

9. The product placement advertising method of claim 1, wherein the rewards program comprises an on-line sweepstakes-type program.

10. A product placement advertising method comprising:
associating a movie containing at least one product placement advertisement with a rewards program;
enabling a consumer to participate in the rewards program in exchange for the consumer engaging in a transaction to purchase or view the movie;
validating the consumer as having engaged in the transaction;
providing to the consumer a question related to the at least one product placement advertisement; and
awarding a prize to the consumer if the question is answered correctly.

11. The product placement advertising method of claim 10, wherein the rewards program comprises an on-line rewards program.

12. The product placement advertising method of claim 10, wherein the validating the consumer comprises:
providing the consumer a transaction identifier at a point of sale associated with the transaction; and
confirming via a web site associated with the rewards program that the transaction identifier is valid.

13. The product placement advertising method of claim 12, wherein the transaction identifier is provided with the transaction.

14. The product placement advertising method of claim 13, wherein the transaction identifier is provided on at least one of a movie ticket, a sales receipt, and an electronic receipt.

15. The product placement advertising method of claim 10, wherein the rewards program comprises an on-line sweepstakes-type program.

16. A computer system for supporting an on-line movie-viewing rewards program, the computer system comprising:
a server configured to communicate with a computer via a communications network;
a participation validation module executable via the server, the participation validation module comprising logic configured to:
prompt a user of the computer to enter a transaction identifier;
receive the transaction identifier; and
determine whether the transaction identifier is associated with an on-line movie-viewing rewards program; and
a rewards program module executable via the server, the rewards program module comprising logic configured to:
if the transaction identifier is associated with the on-line movie-viewing rewards program:
determine a movie corresponding to the transaction identifier, the movie containing a product placement advertisement;
select a question associated with the product placement advertisement;
prompt the user for a response to the question;
receive the response; and
identify the user as a winner of the on-line movie-viewing rewards program if the response is correct.

17. The computer system of claim 16, wherein the logic configured to determine whether the transaction identifier is associated with the on-line movie-viewing rewards program comprises logic configured to compare the transaction identifier to a database of valid identifiers.

18. The computer system of claim 16, further comprising a questions/movie database adapted to store a plurality of questions and corresponding answers associated with a set of product placement advertisements for each participating movie.

19. The computer system of claim 16, further comprising an advertising analytics database and associated engine for managing user responses to the questions and providing data to advertisers.

20. The computer system of claim 19, further comprising an advertiser tracking tool which communicates with the advertising analytics database and associated engine, the advertiser tracking tool being executable via the server and configured to enable advertisers to interactively interface with the analytics database and associated engine.
